(19) United States
(12) Patent Application Publication
(10) Pub. No.: US 2008/0054754 A1
(43) Pub. Date: Mar. 6, 2008

(54) End plate for electric motor

(75) Inventors: Akinori Hoshino, Nisshin-shi (JP); Haruji Suzuki, Kariya-shi (JP); Shusaku Kamio, Nishio-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/892,934

(22) Filed: Aug. 28, 2007

(30) Foreign Application Priority Data
Aug. 29, 2006 (JP) 2006-231571

(51) Int. Cl. H02K 3/46

(52) U.S. Cl. 310/270

(57) ABSTRACT

An end plate for a motor is provided at an end portion of a layered core and supports the core from both axial directions. The end plate comprises a contact surface, the shape of which corresponds to the shape of a stepped portion provided at the end portion of the core in an axial direction.

### CROSS REFERENCE TO RELATED APPLICATIONS

This application is based on and claims priority under 35 U.S.C. § 119 to Japanese Patent Application 2006-231571, filed on Aug. 29, 2006, the entire content of which is incorporated herein by reference.

### FIELD OF THE INVENTION

The present invention relates to an electric motor and more particularly relates to an end plate used in the electric motor for supporting layered core of the motor from both axial ends.

### BACKGROUND

Conventionally, the electric motor uses a pair of end plates provided at both ends of the core for supporting the core of the motor in axial direction. The end plates are usually fixed to the core and integrated therewith.

Normally, the core is formed with a band shaped electromagnetic steel plate having a flat surface. The core is formed by winding and overlapping the flat portion of the steel plate in a spiral direction. This will form a stepped portion at the beginning of the winding and at the ending of the winding, respectively. This structure is, for example, shown in a prior art (Japanese Patent laid open No. 11-299136A).

If the end plate made by punching out a flat plate by pressing is used to support the core from axial direction, a gap is generated between the end plate and the core end surface. Under this situation, usually an adherent agent is filled into the gap to securely fix the core to the end plate. However, the adherent agent may leak out from the gap, which, eventually deteriorates the adhesion strength.

As another method for eliminating such undesired gap between the end plate and the core end surface, the end plate may be machined to have a complementary shape with an end surface shape of the core to fit with each other. Another method for eliminating the gap is to mold the resin material on to the end plate and the molded end plate is pushed or pressed upon the end surface of the core. Thus the resin is cured to fill the gap between the end plate and the core.

However, these conventional methods need extra process, such as pressing or punching machining process or molding and curing process to eventually increase the cost of manufacturing.

### SUMMARY OF THE INVENTION

It is accordingly an object of the invention to provide an end plate manufactured with less expensive method than those described above.

According to one aspect of the invention, the end plate of the motor is formed by plasticity processing at the core contact surface of the plate to agree the shape to the stepped portion formed at the core end surface in an axial direction.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross sectional view of a motor according to an embodiment of the invention;

FIG. 2 is a front view of the motor with an end plate according an embodiment of the present invention;

FIG. 3 is a front view of an end plate of the motor showing a contact surface side;

FIG. 4 is a side view of a rotor of the motor;

FIG. 5 is a side view of a plasticity processing device according to the invention; and

FIG. 6 is a partial enlarged portion of the end plate processed by using the plasticity-processing device according to FIG. 5.

### DESCRIPTION OF PREFERRED EMBODIMENTS

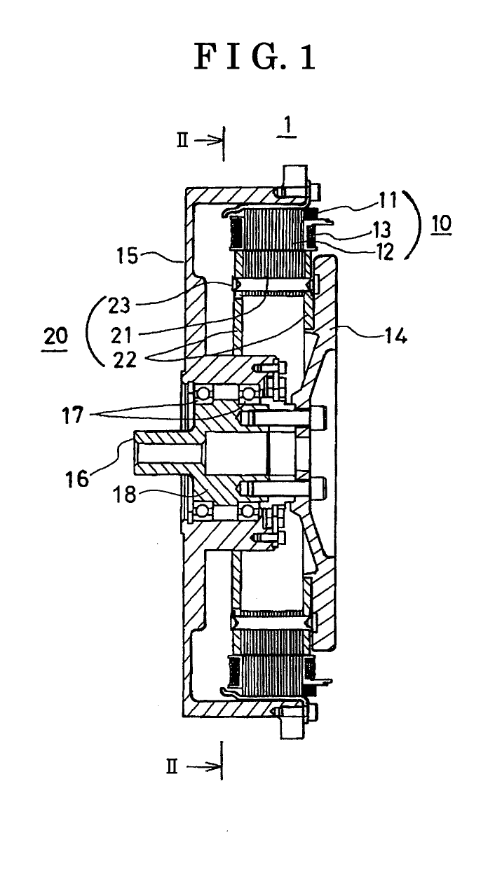

FIG. 1 shows a cross sectional view of a motor 1 in which a pair of end plates 22 of the present invention is used. As shown in FIG. 1, the motor 1 mainly includes a housing 15, a stator 10, a rotor 20 and a flywheel 14. The housing 15 is cylindrical shape having a bottom at one end (left side end in FIG. 1). The housing 15 rotatably supports a shaft 16 by a bearing device 17 disposed between a central portion of the housing 15 and an outer peripheral portion of a boss portion 18 provided at the shaft 16 and projecting inwardly from the central portion of the bottom of the cylinder housing 15. The bearing device 17 includes a pair of ball bearings, which rotatably support the shaft 16 at the bottom of the housing. The flywheel 14 is attached to the shaft 16 by means of bolts (six bolts in this embodiment) for unitary rotation. The rotor 20 is fixed to the shaft 16 for unitary rotation therewith by securing the flywheel 14 to the end plate 22 of the rotor 20. The rotor 20 is arranged coaxial with the cylindrical housing 15 and the flywheel 14. The stator 10 is provided opposing the rotor in a radial direction. The stator 10 includes a stator core 12, a bus ring 11 and a coil 13.

The rotor 20 includes a layered core 21 having a plurality of electromagnetic plates layered in an axial direction and a pair of end plates 22 securing the core 21 from both axial sides. The rotor is coaxially fixed on the shaft for unitary rotation therewith. The rotor structure 20, 21 and 22 is housed in the housing 15 not to be in contact with the inner wall of the housing through the shaft 16.

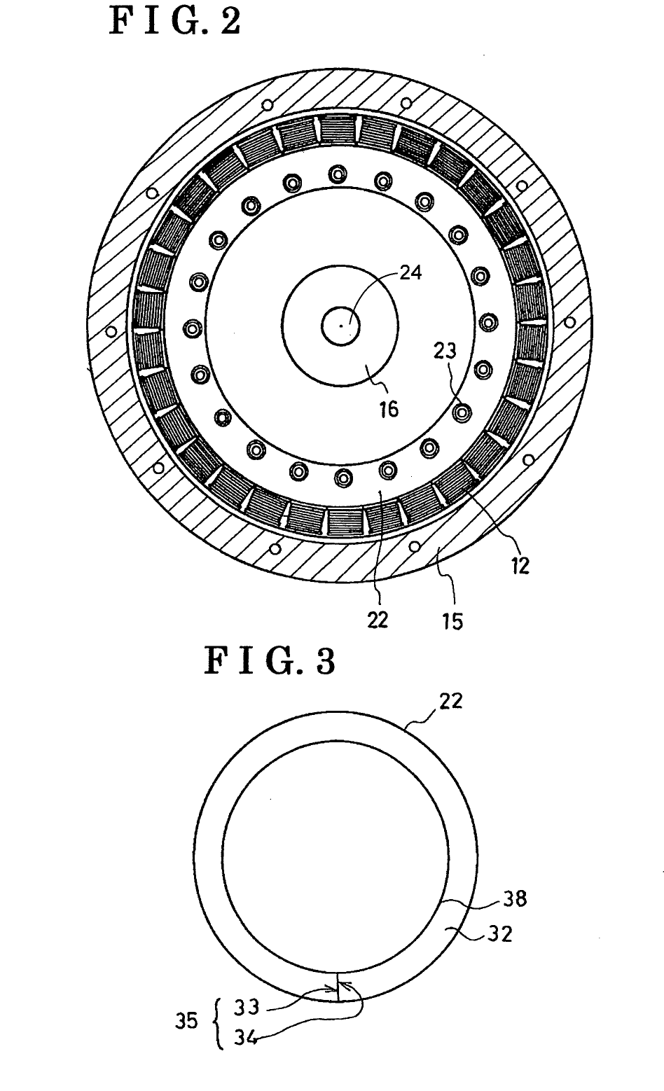

FIGS. 1 and 2 show the end plates 22 and the core 21 assembled to the motor 1. The end plates 22 have a circular shape. The size of the circle corresponds to the outer diameter of the core 21 and each end plate 22 is provided with an axial bore for inserting the shaft 16 therein. The end plates 22 support the core 21 from axial both sides to prevent a leakage of magnetic flux in the axial direction and secure the core 21 in both axial and circumferential directions to maintain the distance between the core 21 and the stator 10 to be constant. Further, the rotor 20 is secured by the end plates 22 for preventing the core 21 from falling off due to the inertia generated when the rotor 20 is rotated.

Rivet pins 23 (20 in number as shown in FIG. 2) are circumferentially provided with a distance equal to each other. The rivet pins 23 connect the end plates 22 and the core 21.

The core 21 is formed by spirally winding a band shaped electromagnetic steel plate to form a layered structure. Accordingly, a spiral-stepped portion 31 is formed in an axial direction at both winding starting and winding end portions of the layered electromagnetic steel plate.

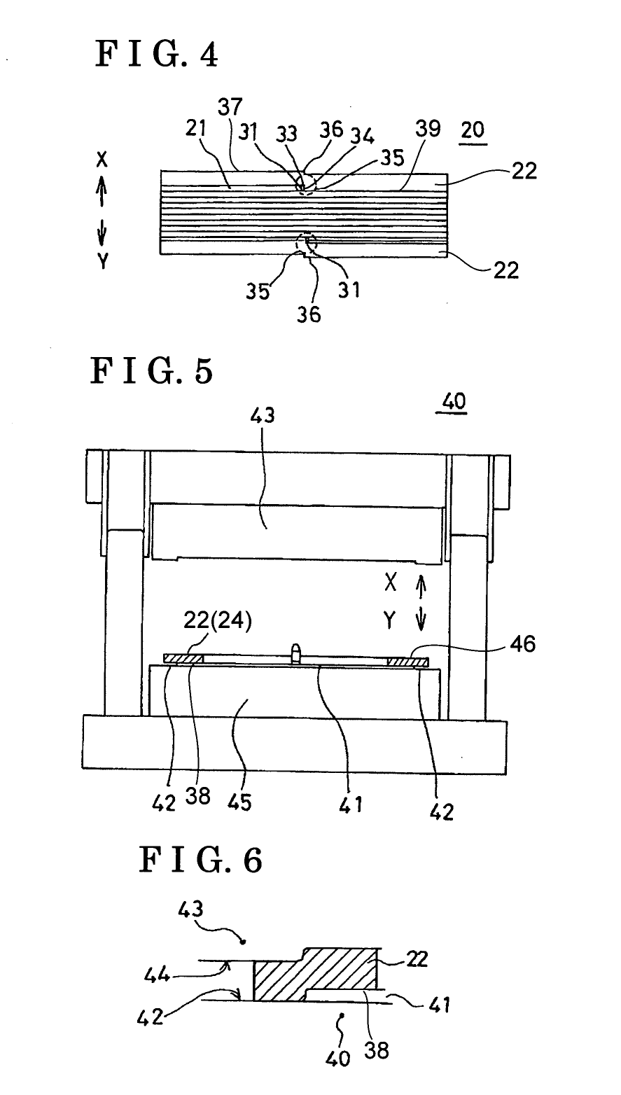

Referring now to the end plate 22 in more detail with FIGS. 3 and 4. At the contact surface of the core 21 with the end plate 22, the stepped portion 31 is formed in axial direction and a sloped plain surface 32, the height of which is gradually changed in circumferential direction.

The starting point 33 in circumferential direction of the sloped plain surface 32 includes the stepped portion 31 at the winding start or end of the core 21. The position corresponding to the winding start of the core 21 includes a stepped portion at a plain end of the sloped plain surface of the end plate 22 to be in contact with the core 21. The starting point 33 corresponds to the most inwardly projecting portion projecting towards the end plate 22 from the contact surface of the core 21 in axial direction.

As shown in FIG. 4, when the core 21 having the stepped portion 31 (starting or ending portion of winding) is in contact with the end plate 22, the stepped portion 31, the stepped portion 31 of the core engages with a contact surface 39 of the end plate 39 formed in circumferential direction. Thus even the height of the core is gradually changed in axial direction, the end plate 22 becomes in contact with the core in circumferential direction to correspond with the shape of each member to fill any gap between the end plate 22 and the core 21 when both are in contact with each other.

The sloped plain surface 32 is formed annually at the contact surface of the end plate 22. As shown in FIG. 4, the contact surface 39 of the end plate with the core 21 is formed with the deepest portion and the shallowest portion in circumferential direction with respect to the starting point 33 of the core 21. The contact surface of the other side end plate 22 has the similar deepest portion and the shallowest portion in circumferential direction with respect to the end point of the core 21.

A plain surface 37 provided at the side where the end plate is not in contact with the core 21 includes a projecting shaped portion 36 in a projecting direction (X and Y direction in FIG. 4) at the sloped plain portion 32 formed on the contact surface 39. The stepped portion 35 is formed without any cutting process. The sloped plain surface 32 formed on the end plate 22 is formed having the same width with the core 21.

When the end plate 22 is assembled into the motor 1, any gap between the contact surfaces of the core 21 and the end plate 22 and the fastening force from the rivet pins 23 are equally applied on the entire sloped plain surface 32. When the fixing process is performed by using adhesion agent, since any gap between the core 21 and the end plate 22, the flowing out of the adhesion agent from the contact surface 39 can be prevented. The fixing of core and end plate can be made by simple riveting method and the manufacturing cost of the rotor 20 can be saved.

Further, the performance of the motor is improved (high speed and high output power) when the rotor 20 of this invention is used due to the evenly distributed riveting force (fastening force) between the end plate and the core to improve the strength of the motor structure.

Next, manufacturing method of the end plate of the motor will be explained in detail. The sloped plain surface portion 32 of the end plate is formed by plasticity processing. FIG. 5 shows the device 40 for machining the end plate. The device includes a dies 45 and a punching portion 43. FIG. 6 shows the end plate 22 after being processed by the dies and the punching portion. The annular end plate 22 is first placed in an axial direction (X and Y directions in FIG. 5) on the dies 45. The device 40 includes a seat portion 41 on which the end plate 22 is held in a horizontal direction. The seat portion 41 has an inner peripheral portion having a diameter smaller than the diameter of the end plate 22. The seat portion 41 may be provided with a plural number, for example four seat portions can be provided having a right angle with each other depending on the conditions of the end plate such as material property, size or pressing force. The seat portion 41 is placed on the contact surfaces of the plain portion 46 of the end plate 22 and the dies 40.

The dies 45 is formed with a shape corresponding to the sloped plain surface 32 at the lower position of the sloped plain surface 32 of the core 21. The shape includes a dies stepped portion 42. The depth and the width of the dies stepped portion 42 is determined by the depth and the width of the sloped plain surface 32 and spring back amount after the processing.

The punching portion 43 includes a complementary projected sloped plain surface with respect to the stepped portion 31 of the core. The raw material 24 of the end plate 22 is placed on the dies 45 and then is pressed by the punching portion 43 at the portion where the material 24 becomes in contact with the core 21. The sloped portion 32 is formed at the pressing portion of the punching portion. The opposite surface to the contact surface of the punching portion 43 in axial direction where the dies stepped portion 42 is in contact with to form the sloped steeped portion 32.

The motor can be manufactured without increasing the processing steps or the hours therefor to reduce the manufacturing cost.

Next, the operation of the motor 1 will be explained. When the coil 13 is energized by the power source (not shown) through the bus ring 11, the stator core 12 is magnetized to generate a force (either suction or reaction) between the stator core 12 and a permanent magnet provided at the core 21. The rotor 20 is thus rotated about the shaft 16.

The end plate 22 is effective to refrain the magnetic flux generated at the stator core 12 in an axial direction of the rotor 20 and to concentrate the magnetic flux in a circumferential direction of the rotor 20. The motor is operated keeping the tight connection between the end plate and the core 21 by securing from both axial directions by the riveting.

According to an aspect of the invention, the end plate of the motor is formed by plasticity processing at the core contact surface of the plate to agree the shape to the stepped portion formed at the core end surface in a peripheral direction.

It is preferable to form the stepped portion having a thickness corresponding to that of the layered core.

It is also preferable to form the contact surface having a sloped shape along the core end shape.

It is also preferable to form the contact surface having a sloped shape from the stepped portion.

It is still further preferable to fix the end plate to the core by using a plurality of fixing pins. The plurality of pins may be provided with an equal distance with each other in a circumferential direction.

It is preferably to form the stepped portion of the core by plasticity processing.

The principles, preferred embodiment and mode of operation of the present invention have been described in the foregoing specification. However, the invention, which is intended to be protected, is not to be construed as limited to the embodiment disclosed. Further, the embodiments described herein are to be regarded as illustrative rather than restrictive. Others may make variations and changes, and equivalents employed, without departing from the spirit of the present invention. Accordingly, it is expressly intended that all such variations, changes and equivalents that fall within the spirit and scope of the present invention as defined in the claims, be embraced thereby.

What we claim is:

1. An end plate for a motor provided at an end portion of a layered core and supporting the core from both axial directions, the end plate comprising a contact surface, the shape of which corresponds to the shape of a stepped portion provided at the end portion of the core in an axial direction.

2. An end plate for a motor provided at an end portion of a layered core and supporting the core from both axial directions, the end plate comprising a contact surface, the shape of which corresponds to the shape of a stepped portion provided at the end portion of the core in a circumferential direction.

3. The end plate according to claim 1, wherein the stepped portion includes a width corresponding to the width of the layered core.

4. The end plate according to claim 1, wherein the contact surface has a sloped shape provided along the end portion of the core.

5. The end plate according to claim 1, wherein the contact surface has a sloped shape from the stepped portion.

6. The end plate according to claim 1, wherein a plurality of pins are provided for securing to the core.

7. The end plate according to claim 1, wherein a plurality of pins are provided in a circumferential direction having an equal interval with one another.

8. The end plate according to claim 1, wherein the stepped portion is formed by a plasticity processing.
